(19) United States
(12) Patent Application Publication
(10) Pub. No.: US 2026/0143204 A1
(43) Pub. Date: May 21, 2026

(54) METHOD FOR DATA ANALYZING MEDIA APPLICATION, ELECTRONIC DEVICE AND STORAGE MEDIUM

(71) Applicant: Beijing Zitiao Network Technology Co., Ltd., Beijing (CN)

(72) Inventors: Bin HUANG, Beijing (CN); Qing YANG, Beijing (CN); Qiuhong XU, Beijing (CN); Jinxue HUANG, Beijing (CN)

(21) Appl. No.: 19/317,026

(22) Filed: Sep. 2, 2025

(30) Foreign Application Priority Data
Nov. 20, 2024 (CN) 202411667736.4

(51) Int. Cl. H04N 21/81; H04N 21/466; H04N 21/4788

(52) U.S. Cl. CPC H04N 21/8113; H04N 21/4668; H04N 21/4788

(57) ABSTRACT

The present disclosure provides a method for data analyzing a media application, an electronic device and a storage medium. The method includes: displaying, in response to a display instruction for a management page of the media application, a management page, a data analysis control being displayed on the management page; displaying, in response to an interactive instruction on the data analysis control, a data analysis page; displaying, in response to an input instruction on an analytical object on the data analysis page, an analysis result of the analytical object and an operation control corresponding to the analysis result on the data analysis page, the operation control being used to trigger display of a processing page corresponding to the analysis result, and the analytical object including at least one media work.

### CROSS-REFERENCE TO RELATED APPLICATION

The present disclosure claims priority of the Chinese Patent Application No. 202411667736.4 filed on Nov. 20, 2024, the disclosure of which is incorporated herein by reference in its entirety as part of the present application.

### TECHNICAL FIELD

The present disclosure relates to a method for data analyzing a media application, an electronic device and a storage medium.

### BACKGROUND

Users who post their own works through media applications can be called creators. For these creators, they expect their works to have a high activity level and attract more people's attention. However, most of these creators are not good at the daily maintenance of media applications, which may lead to a low activity level of their created works. Therefore, it is necessary to provide a method for data analyzing a media application, to improve the activity level of media works in the media application.

### SUMMARY

The present disclosure provides a method for data analyzing a media application, including:
displaying, in response to a display instruction for a management page of the media application, a management page, where a data analysis control is displayed on the management page;
displaying, in response to an interactive instruction on the data analysis control, a data analysis page; and
displaying, in response to an input instruction on an analytical object on the data analysis page, an analysis result of the analytical object and an operation control corresponding to the analysis result on the data analysis page, where the operation control is used to trigger display of a processing page corresponding to the analysis result, and the analytical object includes at least one media work.

The present disclosure provides an apparatus of data analyzing a media application, including:
a management page display module, configured to display, in response to a display instruction for a management page on the media application, a management page, wherein a data analysis control is displayed on the management page;
a data analysis page display module, configured to display, in response to an interactive instruction on the data analysis control, a data analysis page; and
an analysis result display module, configured to display, in response to an input instruction on an analytical object on the data analysis page, an analysis result of the analytical object and an operation control corresponding to the analysis result on the data analysis page, where the operation control is used to trigger display of a processing page corresponding to the analysis result, and the analytical object includes at least one media work.

The present disclosure provides an electronic device, including: a memory and a processor, where the memory and the processor are in communication connection with each other, computer instructions are stored on the memory, and the processor executes the computer instructions, to execute the method for data analyzing the media application corresponding to the above or any implementation of the above.

The present disclosure provides a computer-readable storage medium, where computer instructions are stored on the computer-readable storage medium, and the computer instructions are used to cause a computer to execute the method for data analyzing the media application corresponding to the above or any implementation of the above.

The present disclosure provides a computer program product including computer instructions and the computer instructions are used to cause a computer to execute the method for data analyzing the media application corresponding to the above or any implementation of the above.

### BRIEF DESCRIPTION OF DRAWINGS

To describe the technical solutions in the embodiments of the present disclosure or in the prior art more clearly, the accompanying drawings required in the description of the embodiments or the prior art will be described briefly below. Apparently, other accompanying drawings can also be derived from these drawings by those ordinarily skilled in the art without creative efforts.

FIG. 1 is a schematic flowchart of a method for data analyzing a media application according to an embodiment of the present disclosure;

FIG. 2 is a schematic diagram of a management page according to an embodiment of the present disclosure;

FIG. 3 is a schematic diagram of a data analysis page according to an embodiment of the present disclosure;

FIG. 4 is a schematic diagram of a description page according to an embodiment of the present disclosure;

FIG. 5 is a schematic diagram of a playback page according to an embodiment of the present disclosure;

FIG. 6 is a schematic diagram of a sharing page according to an embodiment of the present disclosure;

FIG. 7 is a schematic diagram of a video shooting page according to an embodiment of the present disclosure;

FIG. 8 is a schematic diagram of a work recommendation page according to an embodiment of the present disclosure;

FIG. 9 is a schematic diagram of a work recommendation page according to an embodiment of the present disclosure;

FIG. 10 is a schematic diagram of a data analysis page according to an embodiment of the present disclosure;

FIG. 11 is a schematic diagram of a work analysis page according to an embodiment of the present disclosure;

FIG. 12 is a schematic diagram of a new work posting page according to an embodiment of the present disclosure;

FIG. 13 is a schematic diagram of a group creation page according to an embodiment of the present disclosure;

FIG. 14 is a structural block diagram of an apparatus of data analyzing a media application according to an embodiment of the present disclosure; and

FIG. 15 is a schematic diagram of a hardware structure of an electronic device according to the embodiment of the present disclosure.

### DETAILED DESCRIPTION

To make the objectives, technical solutions, and advantages of embodiments of the present disclosure clearer, the technical solutions in the embodiments of the present disclosure will be described clearly and comprehensively below in conjunction with the accompanying drawings. Obviously, the described embodiments are a part of the embodiments of this disclosure, not all of them. Based on the embodiments in the present disclosure, all other embodiments obtained by those skilled in the art without creative effort fall within the scope of protection of the present disclosure.

It is understandable that before the technical solutions disclosed in the embodiments of the present disclosure are used, the types, scope of use, usage scenarios, and the like of personal information involved in the present disclosure shall be informed to users and the users'authorization shall be obtained through appropriate means in accordance with relevant laws and regulations.

For example, when receiving an active request from a user, a prompt message is sent to the user to explicitly prompt the user that the operation requested by the user will need to obtain and use the user's personal information. Therefore, the user can voluntarily choose whether to provide personal information to a software or hardware such as an electronic device, an application, a server, or a storage medium that performs an operation of the technical solution of the present disclosure based on the prompt information.

As an optional but non-restrictive implementation, in response to receiving an active request from a user, the manner of sending a prompt message to the user may be, for example, a pop-up window, and the prompt message may be presented in the pop-up window in text. In addition, the pop-up window may also carry a selection control for the user to select “agree” or “disagree” to provide personal information to the electronic device.

It is understandable that the above process of notifying and obtaining the user authorization is only illustrative and does not constitute a limitation on the implementation of the present disclosure. Other manners that comply with relevant laws and regulations may also be applied to the implementation of the present disclosure.

It is understandable that data involved in the technical solution (including but not limited to the data itself, data acquisition, or data use) shall comply with requirements of corresponding laws and regulations and related provisions.

The assistant of a media application generally provides suggestions based on fixed templates, which may solve some problems. However, due to the fixed templates, it is difficult to provide personalized suggestions, resulting in a narrow scope of application. Accordingly, from the perspective of improving the activity level of media works, the effect is not obvious.

Based on this, an embodiment of the present disclosure provides a method for data analyzing a media application. A data analysis control is provided on a management page, and a data analysis page can be displayed through interaction with the data analysis control. An analysis result of a media work is displayed on the data analysis page through interactive means. In addition, the analysis result also corresponds to an operation control, and subsequently, the analysis result can be further processed through interaction with the operation control.

According to the embodiments of the present disclosure, an embodiment of a method for data analyzing a media application is provided. It should be noted that the steps shown in the flowchart of the attached drawings can be executed, for example, in a computer system including a set of computer-executable instructions, and although a logical order is shown in the flowchart, in some cases, the steps shown or described can be executed in a different order from herein.

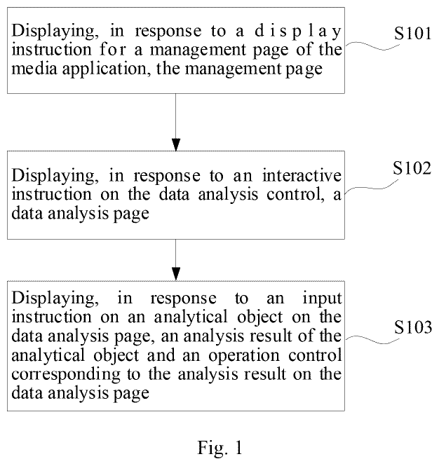

In the present embodiment, a method for data analyzing a media application is provided, which can be applied in an electronic device, such as a mobile terminal, etc. FIG. 1 is a flowchart of a method for data analyzing a media application according to an embodiment of the present disclosure, as shown in FIG. 1, the flow includes the following steps:

Step S101: Displaying, in response to a display instruction for a management page of the media application, a management page.

A data analysis control is displayed on the management page.

The media application includes, but is not limited to, text quotation, music playback application, short video application, video playback application, etc. ; there is no restriction on its usage scenario here, and it can be set according to actual needs. After opening the media application, by triggering the display of a management page, the management page is displayed accordingly. For example, after the media application is opened, the home page of the media application is displayed, and a label of the management page is provided on the home page. Through interaction with the label of the management page, a display instruction for the management page is generated, and a management page can be displayed in response to this instruction.

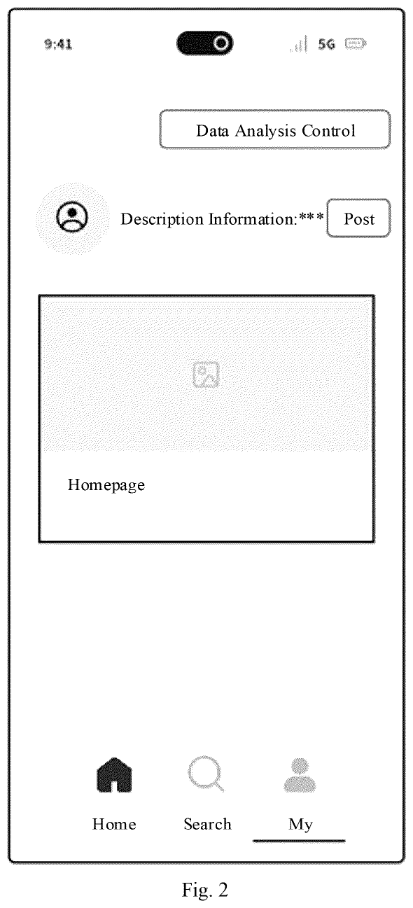

For example, as shown in FIG. 2, the management page includes the homepage content, identifier, description information or the like of the media application. Further, the management page further includes a data analysis control, which is used to trigger the display of a data analysis page.

In addition, a posting control can also be displayed on the management page, and a posting instruction is generated through interaction with the posting control, and a posting flow of a media work can be entered in response to the posting instruction.

It should be noted that the data analysis control shown in FIG. 2 is characterized by a button, but it does not limit the protection scope of the present disclosure. The data analysis control can be displayed in other ways; for example, the data analysis control can be displayed through a drop-down menu, or it can be displayed through a bubble, and so on. There is no restriction on the display form of the data analysis control here.

Step S102: Displaying, in response to an interactive instruction on the data analysis control, a data analysis page.

The user generates an interactive instruction by interacting with the data analysis control on the homepage, and the display of the data analysis page is triggered in response to the interactive instruction. The data analysis page can also be understood as obtaining a desired result through man-machine conversation.

Of course, in the process of conversation through the data analysis page, the identifiers of both parties of the conversation may or may not be displayed.

Step S103: Displaying, in response to an input instruction on an analytical object on the data analysis page, an analysis result of the analytical object and an operation control corresponding to the analysis result on the data analysis page.

The operation control is used to trigger the display of a processing page corresponding to the analysis result, and the analytical object includes at least one media work.

On the data analysis page, the user inputs the question he/she wants to consult in an interactive way, that is, the question for the analytical object is input in an interactive way; and accordingly, an input instruction of the analytical object is generated. In response to the input instruction, the analysis result of the analytical object and the operation control corresponding to the analysis result can be displayed on the data analysis page.

The analytical object includes at least one media work. Specifically, the question about a certain media work can be consulted on the data analysis page, and the corresponding analysis result can be displayed on the data analysis page. On the data analysis page, questions about all media works posted by the owner of the media application can also be consulted, and the corresponding analysis results can be displayed. Further, other questions can also be consulted on the data analysis page, which is not limited here.

While the data analysis page displays the analysis results, it also displays operation controls corresponding to various analysis results. That is, for each analysis result, the user can trigger further analysis or processing through interaction with a corresponding operation control, and thus, the user is guided to further process the consulted analytical object.

For example, a question about a media work is consulted, then the analysis result can include several methods to improve the following degree of a music work, and a corresponding operation guideline is provided through an operation control for each method.

Subsequently, the user triggers the display of a processing page corresponding to the analysis result through the interaction with the operation control. The processing page includes but is not limited to work sharing, work recommendation and work analysis, etc. Specifically, the display content of the processing page corresponds to the corresponding operation controls, and the operation controls correspond to the analysis results.

According to the method for data analyzing the media application provided by the present embodiment, a data analysis control is displayed on the management page, and the analysis of media works in the media application is realized through interaction with the data analysis control, and the analysis result of the analytical object is displayed, and at the same time, an operation control corresponding to the analysis result is provided, so as to facilitate further analysis and processing. This method provides an interactive approach for in-depth data analysis of the media application, and offers some analysis results for the user to choose from. Combining the analysis results and corresponding operation controls can improve the activity level of media works in the media application.

In some optional implementations, the above step S102 includes: displaying, in response to an input instruction on first analysis prompt information of the analytical object on the data analysis page, at least one first analysis result of the analytical object and an operation control corresponding to the at least one first analysis result on the data analysis page.

For the analysis of the analytical object, it is necessary to provide the media work to be analyzed on the data analysis page. In the following description, the media works are music works as an example. Through the interaction with the data analysis page, the analytical object and the first analysis prompt information are input, and accordingly, an input instruction is generated. In response to the input instruction, the input analytical object and first analysis prompt information are displayed on the data analysis page; in addition, at least one first analysis result of the analytical object and an operation control corresponding to the first analysis result are also displayed.

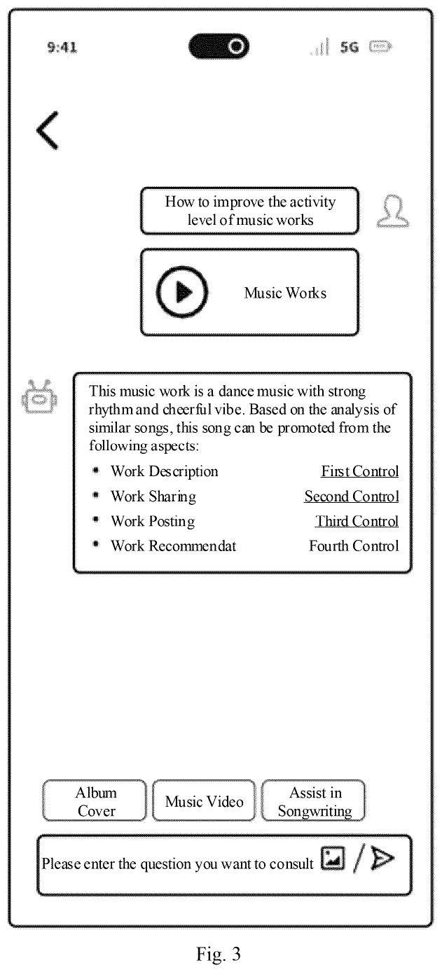

For example, as shown in FIG. 3, the user can input the music work and the first analysis prompt information by interacting with the dialog box on the data analysis page. In addition, the music work can be input to the data analysis page in the form of adding files, or by dragging and dropping or the like, or by inputting prompt information in the dialog box to obtain the music work, and so on. There is no restriction on the input form of the music work here, and it can be specifically set according to actual needs.

The first analysis prompt information is used to characterize the question description for the analytical object, such as “How to improve the activity level of music works” shown in FIG. 3, and so on. The specific content of the first analysis prompt information is input according to the actual scenario, which is not limited here.

After the analytical object and the first analysis prompt information are input, the corresponding analysis results are displayed on the data analysis page. As described above, each analysis result corresponds to an operation control. The number of analysis results of the analytical object can be one or more, which is set according to actual needs.

It should be noted that the layout of the first analysis results and the corresponding operation controls is not limited to that shown in FIG. 3, and can be set according to actual needs, which is not limited here.

When analyzing the analytical object, the analytical object and the first analysis prompt information are input on the data analysis page, so as specify the analysis of the analytical object, and accordingly, at least one first analysis result and an operation control corresponding to the first analysis result are displayed, so that the analysis results can be displayed intuitively.

Further, the page shown in FIG. 3 further includes controls such as album cover, music video, assist in songwriting, etc. Through interaction with these controls, a corresponding page can be entered to realize a corresponding function. For example, through interaction with the assist in songwriting control, a songwriting page can be entered; some prompt words or scenarios, etc. can be provided, to generate corresponding lyrics and so on.

In addition, in FIG. 3, both parties participating in the session are displayed with identifiers, but this does not limit the protection scope of the present disclosure. That is, the identifiers may not be displayed, or may be replaced with other information, and so on.

The first analysis results include analysis results applicable to all media works and personalized analysis results. For example, on the data analysis page shown in FIG. 3, the work description can belong to the analysis results applicable to all media works, and the work sharing, work posting and work recommendation can belong to the personalized analysis results.

It should be noted that FIG. 3 merely shows some examples of the first analysis results, and it does not limit the protection scope of the present disclosure, which can be set according to actual needs. That is, in other scenarios, the number of the first analysis results is not limited to four as shown in FIG. 3, but can also be three, or five, etc., and the specific number is not limited here.

The first analysis results include general analysis results and personalized analysis results, which can not only meet general needs, but also ensure personalized analysis.

Hereinafter, it will be described in detail by taking as an example that the first analysis results shown in FIG. 3 include the work description, work sharing, work posting and work recommendation.

In some optional implementations, the first analysis result includes work description, and an operation control corresponding to the work description is a first control. Based on this, the method for data analyzing the media application further includes:
Step a1: Displaying, in response to an interactive instruction on the first control, a description page.
Step a2: Displaying, in response to an input instruction on the description page, description information of the analytical object on the description page, where the description information of the analytical object is used to be displayed on a playback page of the analytical object or in comment information of the analytical object.

The first control corresponds to the work description, and through interaction with the first control, the page corresponding to the work description is triggered, that is, the display of the description page is triggered. Specifically, the user generates an interactive instruction of the first control through interaction with the first control, and accordingly, a description is displayed in response to the interactive instruction.

The description page is used to provide a page for the user to input description information about the analytical object. Through interaction with the description page, the user generates an input instruction of the description page, and accordingly, in response to the input instruction, the description information of the analytical object is displayed on the description page.

For example, the input form of description information can be text input, or it can be speech input and then converted into text display, or it can be obtained from other places, and so on. There is no restriction on the input form of description information here, and it can be set according to actual needs.

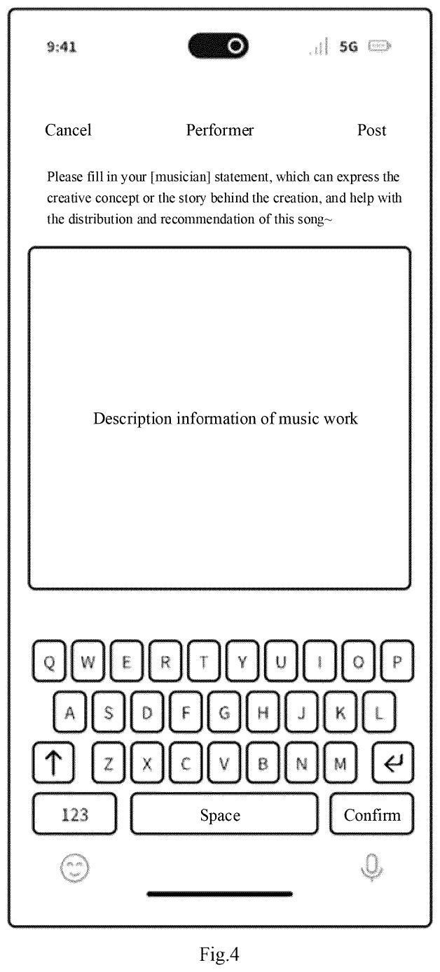

For example, taking a music work as an example, as shown in FIG. 4, an input area of description information is displayed on the description page, and the user can input the description information of the analytical object through interaction with the input area. In addition, the description page further displays input prompt information, so that the user can intuitively understand the function of this page.

The description page further includes a posting control. Through interaction with the posting control, the description information about the analytical object can be displayed on a playback page of the analytical object or in comment information of the analytical object.

Taking a music work as an example, the playback page of the music work represents a page displayed when the music work is played. Generally speaking, the playback page displays a cover image, lyrics, a comment control, or the like of the music work. If the music work has corresponding description information, the description information can be displayed on the area where the cover image is displayed, or can be displayed by superimposing the description information on the cover image.

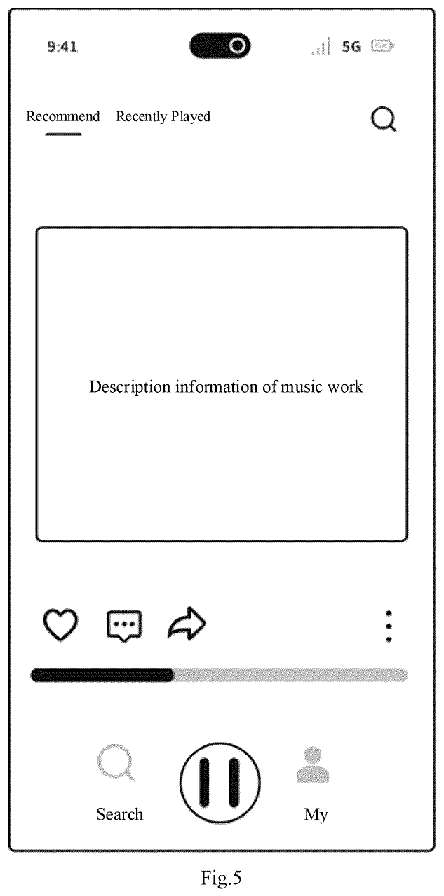

For example, as shown in FIG. 5, the description information of the music work is displayed on the area where the cover image is displayed on the playback page of the music work. Further, if the currently played music work has description information, the corresponding description information is displayed on the area of the cover image on the playback page; if the currently played music work has no description information, the cover image is displayed on the playback page.

By describing the analytical object and displaying the description on the playback page or in the comment information of the analytical object, it is convenient for consumers to know the creative ideas behind the work in time and better understand the analytical object, thus improving the activity level of the analytical object.

In some optional implementations, the first analysis result includes work sharing, and an operation control corresponding to the work sharing is a second control. Based on this, the method for data analyzing the media application further includes: Displaying, in response to an interactive instruction on the second control, a sharing page, where a sharing message and the analytical object are displayed on the sharing page, and a sharing object corresponding to the sharing page includes an object having an association relationship with the analytical object.

The second control corresponds to the work sharing, and the user generates an interactive instruction of the second control through interaction with the second control, and accordingly, the sharing page is displayed. Because the second control is used to trigger work sharing, a sharing page for work sharing is displayed.

In terms of the sharing page corresponding to the analytical object, the sharing object of the analytical object includes an object that has an association relationship with the analytical object. Alternatively, the sharing page can be understood as a group chat page of sharing objects. After the display of the sharing page is triggered, the sharing message and the analytical object are displayed on the sharing page, that is, the automatic sharing of the analytical object is realized. The object that has an association relationship with the analytical object can be an object that performs interaction, such as likes, comments, etc., with the media work, and can also be an object that has played the media work, etc.

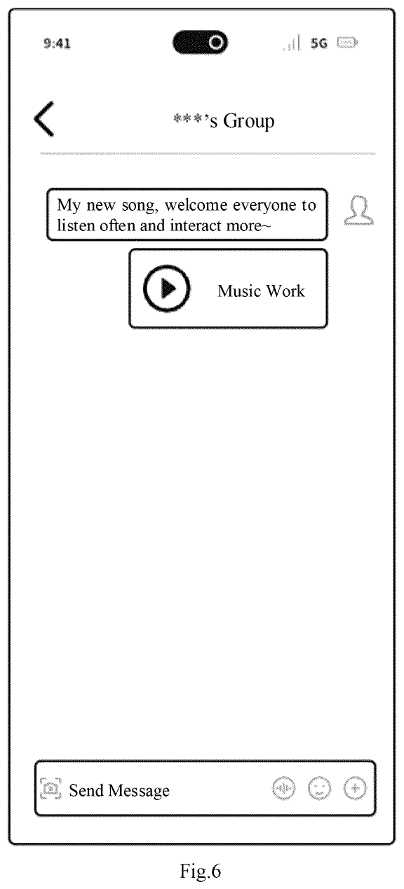

For example, as shown in FIG. 6, a sharing page is displayed through the user's interaction with the second control, and accordingly, a sharing message, such as “My new song, welcome everyone to listen often and interact more,” and the music work are displayed on the sharing page.

It should be noted that the specific content of the sharing message can be automatically sent, and for example, by configuring the specific content of the sharing message, the sharing message is automatically pushed after the display of the sharing page is triggered; or, the sharing message can also be entered manually, and so on. Here, there is no restriction on the specific content and input form of the sharing message, and they can be set according to the actual needs.

Further, as described above, the sharing page can be understood as a group chat page of sharing objects. Then, the sharer of the analytical object and the sharing object can have a conversation on the sharing page.

Because the sharing of the analytical object needs to obtain the object that has an association relationship with the analytical object, if the sharing object is not obtained, it is necessary to create a group of sharing objects before sharing; if the sharing object can be obtained, the display of the sharing page will be triggered directly. Based on this, in some optional implementations, the displaying, in response to an interactive instruction on the second control, a sharing page includes:
Step b1: Displaying, in response to the interactive instruction on the second control, a group creation page if no sharing object is obtained, where the group creation page is displayed after obtaining the object having the association relationship with the analytical object.
Step b2: Displaying, in response to a group creation instruction on the group creation page, the sharing page.

Through interaction with the second control, the user generates an interactive instruction of the second control, and accordingly, the obtaining of the sharing object is triggered; and a group creation page is displayed if no sharing object is obtained. The group creation page is used to guide the user to create a group having an association relationship with the analytical object.

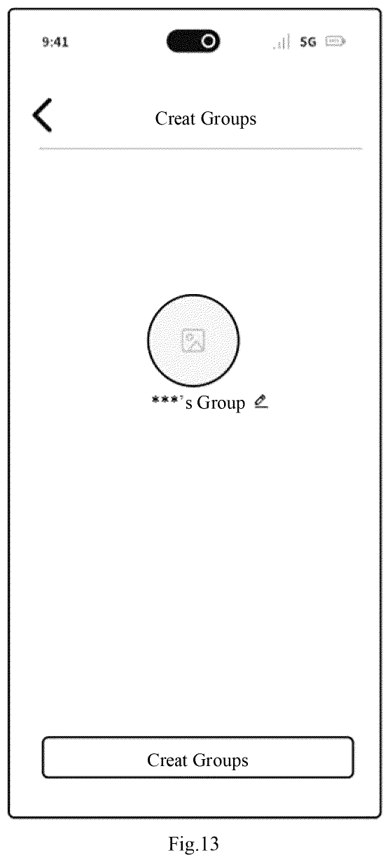

For example, as shown in FIG. 13, in the case where no sharing object is obtained, a group creation page is displayed through interaction with the second control, and the name of a group can be set on this page. After the group is created, the sharing display as shown in FIG. 6 can be triggered, and the music work can be automatically recommended on this page.

In some optional implementations, the first analysis result includes work posting, and an operation control corresponding to the work posting is a third control. Based on this, the method for data analyzing the media application further includes:
Step b1: Displaying, in response to an interactive instruction on the third control, a video shooting page.
Step b2: Obtaining, in response to a shooting instruction on the video shooting page, a shot video, where the analytical object is used as background information of the shot video.

The third control corresponds to the work posting, and the user triggers the posting function of the analytical object through interaction with the third control. In terms of posting the analytical object, the analytical object is taken as the background information of a video. Accordingly, after interaction with the third control, an interactive instruction of the third control is generated, and accordingly, the video shooting page is displayed.

The video shooting page is used to guide the user to shoot a video, and the analytical object is taken as the background information of the shot video.

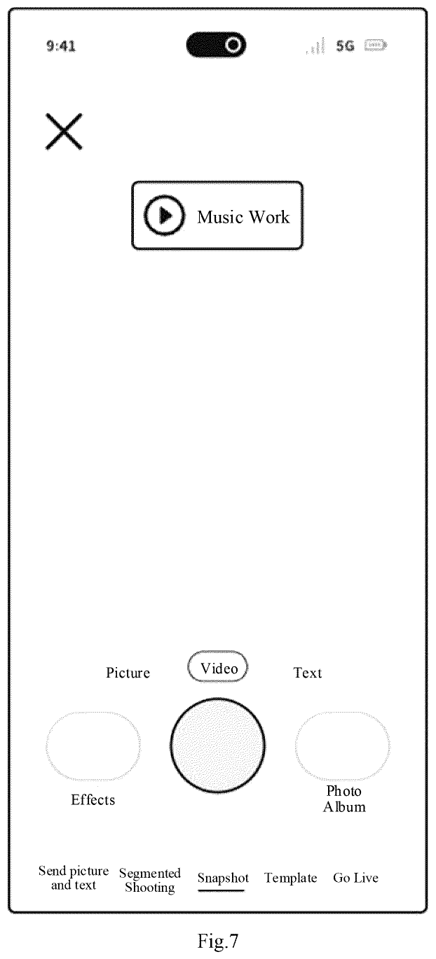

For example, if the analytical object is a music work, as shown in FIG. 7, after interaction with the third control, a video shooting page is displayed. At this time, the music work is automatically set as background music, and the user can obtain the shot video through interaction with the video shooting page. Subsequently, when sharing the shot video, the sharing object can also enjoy the music work serving as background music while watching the shot video.

The analytical object is actively shared to the object having an association relationship with the analytical object through work sharing. Because the object having the association relationship is the interested party of the media work, the playback volume of the analytical object can be improved through targeted sharing.

In some optional implementations, the first analysis result includes work recommendation, and an operation control corresponding to the work recommendation is a fourth control. Based on this, the method for data analyzing the media application further includes: displaying, in response to an interactive instruction on the fourth control, a work recommendation page, where the work recommendation page displays at least one work recommender and a trigger control of the at least one work recommender, and the work recommender is used to recommend the analytical object.

The fourth control corresponds to work recommendation, and the work recommendation can be understood as inviting a work recommender to recommend the analytical object by matching the work recommender corresponding to the analytical object. Specifically, the user generates an interactive instruction of the fourth control through interaction with the fourth control, and accordingly, a work recommendation page is displayed in response to the interactive instruction.

At least one work recommender and a trigger control of the work recommender are displayed on the work recommendation page, where the work recommender can be determined based on attribute information of the analytical object, and the attribute information includes but is not limited to the genre, scene, lyric content and the like of the media work.

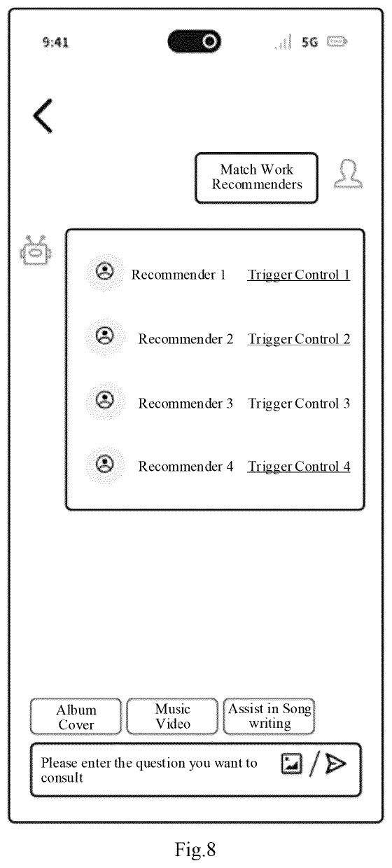

For example, as shown in FIG. 8, after interaction with the fourth control, a work recommendation page is displayed. By inputting the recommendation prompt information “Match work recommenders” on the work recommendation page, recommenders 1-4 and trigger controls 1-4 corresponding to the recommenders 1-4 are displayed on the work recommendation page. Specifically, the number of recommenders displayed on the work recommendation page can be set according to needs, and for example, the maximum number of recommenders is set to 4.

On the work recommendation page, each recommender corresponds to a trigger control. Through interaction with the trigger control, a recommendation plan for the analytical object can be triggered.

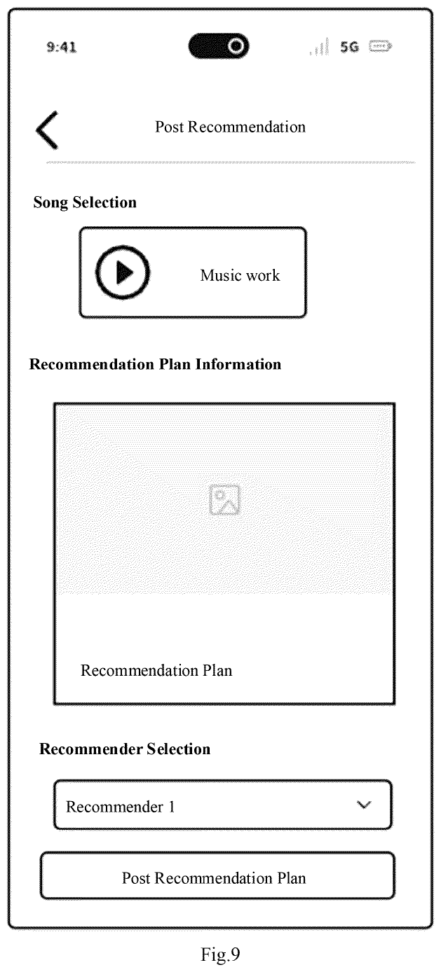

If the user interacts with the trigger control 1 corresponding to recommender 1, a work recommendation page is displayed. For example, as shown in FIG. 9, this page is used to send a recommendation plan to recommender 1, which can include the analytical object needed to be recommended by recommender 1, recommendation plan information, recommender selection, and so on. In FIG. 9, the recommender selection is displayed in the form of a list. If the user interacts with the trigger control 1 corresponding to recommender 1, then recommender 1 is displayed in the list by default; of course, the user can also adjust recommenders according to actual needs. Further, the number of selected recommenders can be one or more, which is not limited here and can be set according to actual needs.

After the user completes the input interaction of the recommendation plan, the recommendation plan will be sent to the selected recommender through the interaction with a posting recommendation plan control. On the corresponding page of the recommender, the recommender can choose whether or not to recommend the analytical object.

Through the work recommendation and the fourth control, the work recommender is triggered to recommend the analytical object, that is, the third party's recommendation is triggered to increase the playback volume of the analytical object, to improve the activity level of the analytical object.

In some optional implementations, the analytical objects include all media works of the owner of the media application.

All the media works of the owner of the media application are analyzed, and the data analysis page is displayed through the user's interaction with the data analysis control. Second analysis prompt information are input for all media works of the owner of the media application on the data analysis page, and accordingly, at least one second analysis result and a corresponding operation control are displayed on the data analysis page.

The display forms of the second analysis result and the operation control corresponding to the second analysis result are similar to the display forms of the first analysis result and the operation control corresponding to the first analysis result, which will not be repeated here.

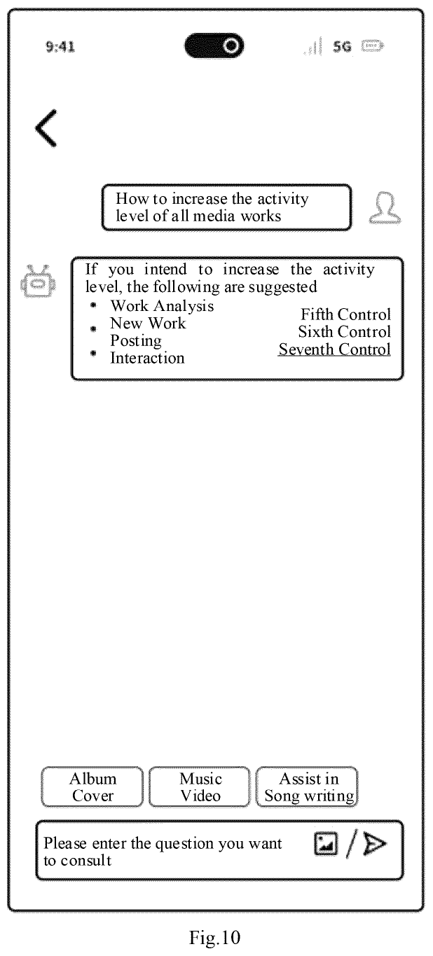

For example, as shown in FIG. 10, the input second analysis prompt information is “How to improve the activity level of all music works,” and accordingly, the second analysis results displayed on the data analysis page include works analysis, new work posting, and interaction. The work analysis, new work posting and interaction correspond to the fifth to seventh controls respectively.

For the account of the media application, the second analysis prompt information is used to trigger work analysis of the media application, and the corresponding second analysis result and the operation control corresponding to the second analysis result are displayed, so that the analysis can be carried out from the perspective of the entire account, and is not limited to a single media work, thus providing a strategy for improving the activity level of all music works of the media application.

In some optional implementations, the first analysis result includes work analysis, and an operation control corresponding to the work analysis is a fifth control. Based on this, the method for data analyzing the media application further includes:
Step c1: Displaying, in response to an interactive instruction on the fifth control, a work analysis page.
Step c2: Displaying, in response to a work analysis instruction on the work analysis page, a work analysis result and a similar analytical object of the media application on the work analysis page, where the similar analytical object is obtained based on attribute information of the analytical object.

The fifth control corresponds to the work analysis, and the user generates an interactive instruction of the fifth control through interaction with the fifth control, and accordingly, the work analysis page is displayed in response to the interactive instruction. The user inputs the analysis prompt information on the work analysis page, and accordingly, the work analysis results and similar analytical objects of the media application are displayed on the work analysis page.

The work analysis result can be a summary of the media works obtained by analyzing all media works of the owner of the media application, including but not limited to genre, style, scene, etc., which is not limited here.

Similar analytical objects of the media application are obtained based on the attribute information of the analytical object. For example, a first feature is obtained by performing feature extraction on the attribute information of the analytical object, and then the similarity is calculated by using the first feature and a second feature corresponding to the attribute information of each object, and some objects with the highest similarities are displayed as similar analytical objects on the work analysis page. For example, four accounts with the highest similarities, or five accounts with the highest similarities, etc., can be selected, and there is no restriction on the specific number of similar analytical objects here.

Through the work analysis and the fifth control, the work analysis on the media application is triggered, and the work analysis result and the similar analytical objects of the media application are displayed, so that the user can seek inspiration from the similar analytical objects to improve the activity level of his/her own media works.

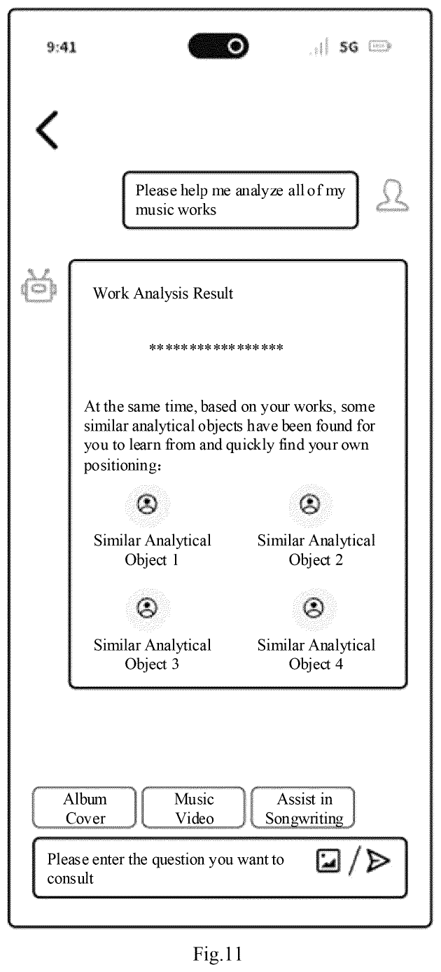

For example, as shown in FIG. 11, the first analysis prompt information is “Please help me analyze all of my music works,” and accordingly, corresponding analysis results, including text analysis results and similar analytical objects, are displayed on the work analysis page shown in FIG. 11.

In some optional implementations, the first analysis result further includes new work posting, and an operation control corresponding to the new work posting is a sixth control. Based on this, the method for data analyzing the media application further includes:
Step d1: Displaying, in response to an interactive instruction on the sixth control, a new work posting page.
Step d2: Displaying, in response to a work recommendation instruction on the new work posting page, prompt information of a newly posted work and a recommended media work on the new work posting page.

The sixth control corresponds to new work posting, and the user generates an interactive instruction through interaction with the sixth control, and accordingly, a new work posting page is displayed in response to the interactive instruction. On the new work page, some new works can be generated, and inspiration for creating new works can also be sought. Specifically, recommendation information of a new work is input on the new work posting page, and a work recommendation instruction is generated, and accordingly, the prompt information of a newly posted work and a recommended media work are displayed on the new work posting page according to the work recommendation instruction.

The prompt information of the newly posted work is used to characterize the aspects from which new works can be created, and the recommended media works are used to characterize media works that match the type of the analytical object. These recommended media works are displayed on the new work posting page, where the number of recommended media works being displayed can be 3, 4 or 5, and so on, and the specific number is not limited here.

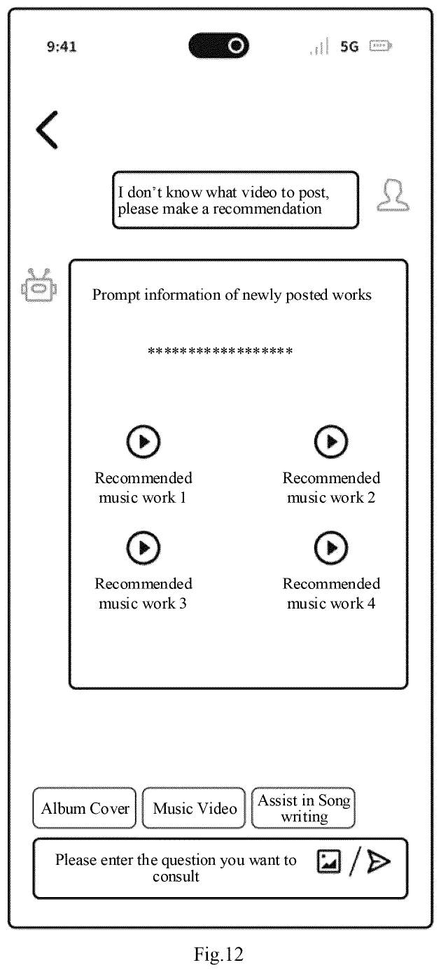

For example, as shown in FIG. 12, the prompt information of the newly posted work and the recommended music works 1 to 4 are displayed on the new work posting page.

The user is guided to post new works, and the prompt information of the newly posted work and recommended media works are displayed on the new work posting page, so that the user can seek inspiration from the prompt information and the recommended media works, and create the newly released work more quickly.

As a specific application implementation of the embodiment of the present disclosure, a short video application is installed on a mobile phone. After opening the short video application, an application homepage is displayed. A management page is entered through interaction with the application homepage, and a data analysis page is entered through interaction with a data analysis control on the management page. According to actual needs, the data analysis control triggers the analysis of a certain music work, or triggers the analysis of an account. On the basis of obtaining a corresponding first analysis result or second analysis result, interactions with a corresponding trigger control is performed according to actual needs, and the subsequent processing is performed according to guidelines.

In the embodiment, an apparatus of data analyzing a media application is further provided, and this apparatus is used to implement the above embodiments and preferred implementations, those having already been described will not be repeated here. As used below, the term “module” can be a combination of software and/or hardware that implements a predetermined function. Although the apparatus described in the following embodiments are preferably implemented in software, the implementation of hardware, or a combination of software and hardware, is also possible and envisioned.

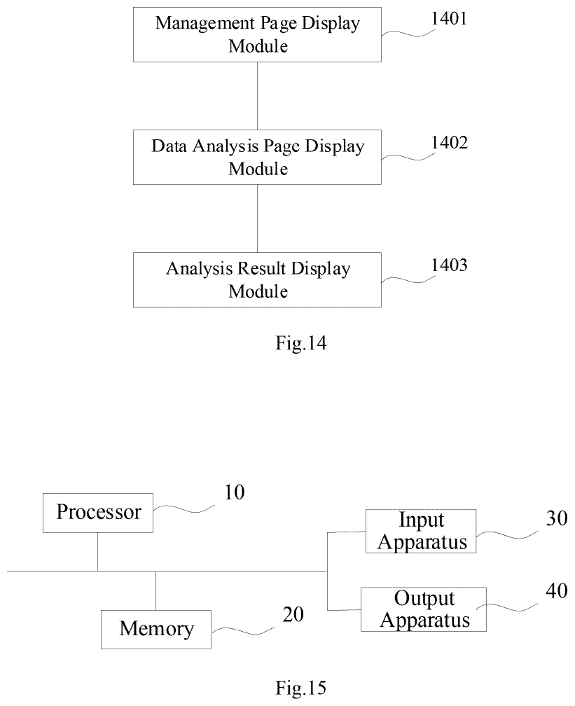

The present embodiment provides an apparatus of data analyzing a media application, as shown in FIG. 14, which includes:
a management page display module 1401, configured to display, in response to a display instruction for a management page of the media application, a management page, where a data analysis control is displayed on the management page;
a data analysis page display module 1402, configured to display, in response to an interactive instruction on the data analysis control, a data analysis page;
an analysis result display module 1403, configured to display, in response to an input instruction on an analytical object on the data analysis page, an analysis result of the analytical object and an operation control corresponding to the analysis result on the data analysis page, where the operation control is used to trigger display of a processing page corresponding to the analysis result, and the analytical object includes at least one media work.

In some optional implementations, the analysis result display module 1403 includes:
a first response unit, configured to display, in response to an input instruction on first analysis prompt information of the analytical object on the data analysis page, at least one first analysis result of the analytical object and an operation control corresponding to the at least one first analysis result on the data analysis page.

In some optional implementations, the first analysis result includes work description, and an operation control corresponding to the work description is a first control, and the apparatus of data analyzing the media application further includes:
a first response module, configured to display, in response to an interactive instruction on the first control, a description page;
a second response module, configured to display, in response to an input instruction on the description page, description information of the analytical object on the description page, where the description information of the analytical object is used to be displayed on a playback page of the analytical object or in comment information of the analytical object.

In some optional implementations, the first analysis result includes work sharing, and an operation control corresponding to the work sharing is a second control, and the apparatus of data analyzing the media application further includes:
a third response module, configured to display, in response to an interactive instruction on the second control, a sharing page, where a sharing message and the analytical object are displayed on the sharing page, and a sharing object corresponding to the sharing page includes an object having an association relationship with the analytical object.

In some optional implementations, the third response module includes:
an object obtaining unit, configured to display, in response to the interactive instruction on the second control, a group creation page if no sharing object is obtained, where the group creation page is displayed after obtaining the object having the association relationship with the analytical object.
a page display unit, configured to display, in response to a group creation instruction on the group creation page, the sharing page.

In some optional implementations, the first analysis result includes work posting, and an operation control corresponding to the work posting is a third control, and the apparatus of data analyzing the media application further includes:
a fourth response module, configured to display, in response to an interactive instruction on the third control, a video shooting page.
a fifth response module, configured to obtain, in response to a shooting instruction on the video shooting page, a shot video, where the analytical object is used as background information of the shot video.

In some optional implementations, the first analysis result includes work recommendation, and an operation control corresponding to the work recommendation is a fourth control, and the apparatus of data analyzing the media application further includes:
a sixth response module, configured to display, in response to an interactive instruction on the fourth control, a work recommendation page, where the work recommendation page displays at least one work recommender and a trigger control of the at least one work recommender, and the trigger control is used to trigger recommendation of a corresponding work recommender on the analytical object.

In some optional implementations, the first analysis result includes work analysis, and an operation control corresponding to the work analysis is a fifth control, and the apparatus of data analyzing the media application further includes:
a seventh response module, configured to display, in response to an interactive instruction on the fifth control, a work analysis page;
an eighth response module, configured to display, in response to a work analysis instruction on the work analysis page, a work analysis result and a similar analytical object of the media application on the work analysis page, where the similar analytical object is obtained based on attribute information of the analytical object.

In some optional implementations, the first analysis result includes new work posting, and an operation control corresponding to the new work posting is a sixth control, and the apparatus of data analyzing the media application further includes:
a ninth response module, configured to display, in response to an interactive instruction on the sixth control, a new work posting page;
a tenth response module, configured to display, in response to a work recommendation instruction on the new work posting page, prompt information of a newly posted work and a recommended media work on the new work posting page.

Further functional descriptions of the above various modules and units are the same as those in the above corresponding embodiments, which are not repeated herein.

The apparatus of data analyzing the media application in the embodiments is presented in the form of functional units. The unit refers to an application specific integrated circuit (ASIC), a processor executing one or more software or fixed programs and a memory, and/or other devices that may provide the above functions.

An embodiment of the present disclosure further provides an electronic device having the apparatus of data analyzing the media application shown in FIG. 14.

Referring to FIG. 15, FIG. 15 is a schematic structural diagram of an electronic device according to an optional embodiment of the present disclosure. As shown in FIG. 15, the electronic device includes: one or more processors 10, a memory 20, and interfaces for connecting various components, including a high-speed interface and a low-speed interface. The various components are in mutual communication connection using different buses and can be installed on a common motherboard or installed in other ways as needed. The processor can process instructions executed within the electronic device, including instructions stored in or on the memory to display graphical information of a graphical user interface (GUI) on an external input/output apparatus (e.g., a display device coupled to an interface). In some optional implementations, a plurality of processors and/or a plurality of buses may be used together with a plurality of memories as needed. Similarly, a plurality of electronic devices may be connected. Each device provides some necessary operations (e.g., as a server array, a set of blade servers, or a multiprocessor system). One processor 10 is taken as an example in FIG. 15.

The processor 10 can be a central processing unit, a network processor, or a combination thereof. The processor 10 can further include a hardware chip. The above hardware chip can be an application specific integrated circuit, a programmable logic device, or a combination thereof. The programmable logic device can be a complex programmable logic device, a field-programmable gate array, a generic array logic, or any combination thereof.

The memory 20 stores instructions executable by at least one processor 10, such that the at least one processor 10 performs the method shown in the above embodiments.

The memory 20 can include a program storage area and a data storage area. The program storage area can store an operating system and an application required by at least one function. The data storage area can store data, etc. created based on the use of the electronic device. In addition, the memory 20 can include a high-speed random access memory, and can also include a non-transitory memory, such as at least one disk storage device, at least one flash memory device, or other non-transitory solid-state storage devices. In some optional implementations, the memory 20 optionally includes memories remotely provided relative to the processor 10. These remote memories can be connected to the electronic device through a network. The examples of the above network include, but are not limited to, the Internet, an intranet, a local area network, a mobile communication network, and any combination thereof.

The memory 20 can include a volatile memory, such as a random access memory. The memory can also include a non-volatile memory, such as a flash memory, a hard disk, or a solid-state hard disk. The memory 20 can also include any combination of the above types of memories.

The electronic device can further include an input apparatus 30 and an output apparatus 40. The processor 10, the memory 20, the input apparatus 30 and the output apparatus 40 can be connected by a bus or other means, and FIG. 15 takes the connection by a bus as an example.

The input apparatus 30 can receive input numeric or character information and generate key signal input related to user settings and function control of the electronic device, such as a touch screen, a keypad, a mouse, a track pad, a touch pad, a pointing stick, one or more mouse buttons, a trackball, a joystick, or the like. The output apparatus 40 can include a display device, an auxiliary lighting apparatus (e.g., an LED) and a tactile feedback apparatus (e.g., a vibration motor), or the like. The display device can include, but is not limited to, a liquid crystal display (LCD), a light emitting diode (LED) display, and a plasma display. In some optional implementations, the display device can be a touch screen.

An embodiment of the present disclosure further provides a computer-readable storage medium. The method according to the embodiments of the present disclosure can be implemented in hardware or firmware, or can be implemented as computer code that can be recorded on a storage medium, or is originally stored on a remote storage medium or a non-transitory machine-readable storage medium and is downloaded through the network and then is stored on a local storage medium, and therefore, the method described herein can be processed by software that is stored on a storage medium using a general-purpose computer, a dedicated processor, or programmable or specialized hardware. The storage medium can be a magnetic disk, an optical disk, a read-only memory, a random access memory, a flash memory, a hard disk, a solid-state hard disk or the like. Further, the storage medium can also include any combination of the above types of memories. It should be understood that a computer, processor, microprocessor controller, or programmable hardware includes a storage component that can store or receive software or computer code. When the software or the computer code is accessed and executed by the computer, processor, or hardware, the method shown in the above embodiments is implemented.

A part of the present disclosure can be applied as a computer program product, such as computer program instructions. The computer program instructions, when executed by a computer, can invoke or provide the method and/or technical solution according to the present disclosure through operations of the computer. Those skilled in the art should understand that a form of the computer program instruction in the computer-readable medium includes, but is not limited to, a source file, an executable file, an installation package file, and the like. Accordingly, a manner in which the computer program instructions are executed by the computer includes, but is not limited to the following: the computer directly executes the instructions, or the computer compiles the instructions and then executes the corresponding compiled program., or the computer reads and executes the instructions, or the computer reads and installs the instructions and then executes the corresponding installed program. Here, the computer-readable medium can be any available computer-readable storage medium or communication medium that can be accessed by the computer.

Although the embodiments of the present disclosure are described with reference to the accompanying drawings, those skilled in the art may make various modifications and variations without departing from the spirit and scope of the present disclosure, and such modifications and variations fall within the scope defined by the appended claims.

1. A method for data analyzing a media application, comprising:
displaying, in response to a display instruction for a management page of the media application, the management page, wherein a data analysis control is displayed on the management page;
displaying, in response to an interactive instruction on the data analysis control, a data analysis page; and
displaying, in response to an input instruction on an analytical object on the data analysis page, an analysis result of the analytical object and an operation control corresponding to the analysis result on the data analysis page, wherein the operation control is used to trigger display of a processing page corresponding to the analysis result, and the analytical object comprises at least one media work.

2. The method according to claim 1, wherein the displaying, in response to an input instruction on an analytical object on the data analysis page, an analysis result of the analytical object and an operation control corresponding to the analysis result on the data analysis page, comprises:
displaying, in response to an input instruction on first analysis prompt information of the analytical object on the data analysis page, at least one first analysis result of the analytical object and an operation control corresponding to the at least one first analysis result on the data analysis page.

3. The method according to claim 2, wherein the at least one first analysis result comprises work description, and an operation control corresponding to the work description is a first control; and the method further comprises:
displaying, in response to an interactive instruction on the first control, a description page; and
displaying, in response to an input instruction on the description page, description information of the analytical object on the description page, wherein the description information of the analytical object is used to be displayed on a playback page of the analytical object or in comment information of the analytical object.

4. The method according to claim 2, wherein the at least one first analysis result comprises work sharing, and an operation control corresponding to the work sharing is a second control; and the method further comprises:
displaying, in response to an interactive instruction on the second control, a sharing page, wherein a sharing message and the analytical object are displayed on the sharing page, and a sharing object corresponding to the sharing page comprises an object having an association relationship with the analytical object.

5. The method according to claim 4, wherein the displaying, in response to an interactive instruction on the second control, a sharing page, comprises:
displaying, in response to the interactive instruction on the second control, a group creation page when no sharing object is obtained, wherein the group creation page is displayed after obtaining the object having the association relationship with the analytical object; and
displaying, in response to a group creation instruction on the group creation page, the sharing page.

6. The method according to claim 2, wherein the at least one first analysis result comprises work posting, and an operation control corresponding to the work posting is a third control; and the method further comprises:
displaying, in response to an interactive instruction on the third control, a video shooting page; and
obtaining, in response to a shooting instruction on the video shooting page, a shot video, wherein the analytical object is used as background information of the shot video.

7. The method according to claim 2, wherein the at least one first analysis result comprises work recommendation, and an operation control corresponding to the work recommendation is a fourth control; and the method further comprises:
displaying, in response to an interactive instruction on the fourth control, a work recommendation page, wherein the work recommendation page displays at least one work recommender and a trigger control of the at least one work recommender, and the trigger control is used to trigger recommendation of a corresponding work recommender on the analytical object.

8. The method according to claim 2, wherein the at least one first analysis result comprises work analysis, and an operation control corresponding to the work analysis is a fifth control; and the method further comprises:
displaying, in response to an interactive instruction on the fifth control, a work analysis page; and
displaying, in response to a work analysis instruction on the work analysis page, a work analysis result and a similar analytical object of the analytical object on the work analysis page, wherein the similar analytical object is obtained based on attribute information of the analytical object.

9. The method according to claim 2, wherein the at least one first analysis result comprises new work posting, and an operation control corresponding to the new work posting is a sixth control; and the method further comprises:
displaying, in response to an interactive instruction on the sixth control, a new work posting page; and
displaying, in response to a work recommendation instruction on the new work posting page, prompt information of a newly posted work and a recommended media work on the new work posting page.

10. An electronic device, comprising:
at least one memory and at least one processor, wherein the at least one memory and the at least one processor are in communication connection with each other, computer instructions are stored on the at least one memory, and the at least one processor executes the computer instructions, to execute a method for data analyzing a media application, and the method comprises:
displaying, in response to a display instruction for a management page of the media application, the management page, wherein a data analysis control is displayed on the management page;
displaying, in response to an interactive instruction on the data analysis control, a data analysis page;
displaying, in response to an input instruction on an analytical object on the data analysis page, an analysis result of the analytical object and an operation control corresponding to the analysis result on the data analysis page, wherein the operation control is used to trigger display of a processing page corresponding to the analysis result, and the analytical object comprises at least one media work.

11. The electronic device according to claim 10, wherein the displaying, in response to an input instruction on an analytical object on the data analysis page, an analysis result of the analytical object and an operation control corresponding to the analysis result on the data analysis page, comprises:
displaying, in response to an input instruction on first analysis prompt information of the analytical object on the data analysis page, at least one first analysis result of the analytical object and an operation control corresponding to the at least one first analysis result on the data analysis page.

12. The electronic device according to claim 11, wherein the at least one first analysis result comprises work description, and an operation control corresponding to the work description is a first control; and the method further comprises:
displaying, in response to an interactive instruction on the first control, a description page;
displaying, in response to an input instruction on the description page, description information of the analytical object on the description page, wherein the description information of the analytical object is used to be displayed on a playback page of the analytical object or in comment information of the analytical object.

13. The electronic device according to claim 11, wherein the at least one first analysis result comprises work sharing, and an operation control corresponding to the work sharing is a second control; and the method further comprises:
displaying, in response to an interactive instruction on the second control, a sharing page, wherein a sharing message and the analytical object are displayed on the sharing page, and a sharing object corresponding to the sharing page comprises an object having an association relationship with the analytical object.

14. The electronic device according to claim 13, wherein the displaying, in response to an interactive instruction on the second control, a sharing page, comprises:
displaying, in response to the interactive instruction on the second control, a group creation page when no sharing object is obtained, wherein the group creation page is displayed after obtaining the object having the association relationship with the analytical object; and
displaying, in response to a group creation instruction on the group creation page, the sharing page.

15. The electronic device according to claim 11, wherein the at least one first analysis result comprises work posting, and an operation control corresponding to the work posting is a third control; and the method further comprises:
displaying, in response to an interactive instruction on the third control, a video shooting page; and
obtaining, in response to a shooting instruction on the video shooting page, a shot video, wherein the analytical object is used as background information of the shot video.

16. The electronic device according to claim 11, wherein the at least one first analysis result comprises work recommendation, and an operation control corresponding to the work recommendation is a fourth control; and the method further comprises:
displaying, in response to an interactive instruction on the fourth control, a work recommendation page, wherein the work recommendation page displays at least one work recommender and a trigger control of the at least one work recommender, and the trigger control is used to trigger recommendation of a corresponding work recommender on the analytical object.

17. The electronic device according to claim 11, wherein the at least one first analysis result comprises work analysis, and an operation control corresponding to the work analysis is a fifth control; and the method further comprises:
displaying, in response to an interactive instruction on the fifth control, a work analysis page; and
displaying, in response to a work analysis instruction on the work analysis page, a work analysis result and a similar analytical object of the analytical object on the work analysis page, wherein the similar analytical object is obtained based on attribute information of the analytical object.

18. The electronic device according to claim 11, wherein the at least one first analysis result comprises new work posting, and an operation control corresponding to the new work posting is a sixth control; and the method further comprises:
displaying, in response to an interactive instruction on the sixth control, a new work posting page; and
displaying, in response to a work recommendation instruction on the new work posting page, prompt information of a newly posted work and a recommended media work on the new work posting page.

19. A non-transitory computer-readable storage medium, wherein computer instructions are stored on the non-transitory computer-readable storage medium, and the computer instructions are used to cause a computer to execute a method for data analyzing a media application, and the method comprises:
displaying, in response to a display instruction for a management page of the media application, a management page, wherein a data analysis control is displayed on the management page;
displaying, in response to an interactive instruction on the data analysis control, a data analysis page;
displaying, in response to an input instruction on an analytical object on the data analysis page, an analysis result of the analytical object and an operation control corresponding to the analysis result on the data analysis page, wherein the operation control is used to trigger display of a processing page corresponding to the analysis result, and the analytical object comprises at least one media work.

20. The non-transitory computer-readable storage medium according to claim 19, wherein the displaying, in response to an input instruction on an analytical object on the data analysis page, an analysis result of the analytical object and an operation control corresponding to the analysis result on the data analysis page, comprises:
displaying, in response to an input instruction on first analysis prompt information of the analytical object on the data analysis page, at least one first analysis result of the analytical object and an operation control corresponding to the at least one first analysis result on the data analysis page.
